(19) United States
(12) Patent Application Publication
(10) Pub. No.: US 2021/0367430 A1
(43) Pub. Date: Nov. 25, 2021

(54) MODULAR CONVERTER FOR CONNECTING TWO VOLTAGE LEVELS

(71) Applicant: Infineon Technologies AG, Neubiberg (DE)

(72) Inventors: Rodrigo Da Silva, Unterhaching (DE); Kevin Pluch, Munich (DE)

(21) Appl. No.: 16/881,805

(22) Filed: May 22, 2020

(51) Int. Cl. H02J 7/00; H02M 3/158

(52) U.S. Cl. CPC H02J 7/0014; H02J 7/0047; H02M 2003/1557; H02M 3/158; H02J 2207/20; H02J 7/0029

(57) ABSTRACT

The disclosure describes techniques to implement an isolated power converter circuit topology. The power converter circuit topology may include a level shifter or a low-side capacitor which may be configured to both provide capacitive isolation as well as clamping between power converter circuits arranged in a stacked or interleaved interconnection configuration. By controlling the drive signals to the power converter circuits, each power converter circuit, and the stacked interconnection of power converter circuits, may operate to convert power from one voltage level to a second voltage level in either a forward or reverse direction. In the example of a direct current (DC) battery, the stacked or interleaved interconnection of power converter circuits may be further configured to balance the charge level and amount of power drawn from each cell of a multi-cell DC battery.

### TECHNICAL FIELD

The disclosure relates to DC-DC power converter circuits.

### BACKGROUND

Power conversion between two different voltage domains may include an input power supply, which is the energy source for a system, and a load, which drains power from the system. Each of the power supply and the load may have different voltages ratings and may also have different characteristics.

### SUMMARY

In general, the disclosure describes techniques to implement an isolated power converter circuit topology. The power converter circuit topology may include a level shifter or a low-side capacitor which may be configured to both provide capacitive isolation as well as clamping between power converter circuits arranged in a stacked or interleaved interconnection configuration. By controlling the drive signals to the power converter circuits, each power converter circuit, and the stacked interconnection of power converter circuits, may operate to convert power from one voltage level to a second voltage level in either a forward or reverse direction. In the example of a direct current (DC) battery, the stacked or interleaved interconnection of power converter circuits may be further configured to balance the charge level and amount of power drawn from each cell of a multi-cell DC battery.

In one example, the disclosure is directed to a circuit comprising a high side capacitor and a low side capacitor, a primary side including a first input element, a first output element, a first reference element. The primary side is configured to receive an input voltage at the first input element. The circuit also includes a secondary side, including a second input element, a second output element and a second reference element, wherein the low side capacitor is connected between the first reference element and the second reference element, wherein the high side capacitor couples the first output element to the second input element, and wherein the secondary side is configured to supply power to a load coupled between the second output element and the second reference element.

In another example, a system comprising: a first circuit, including: a first high side capacitor and a first low side capacitor, a first primary side including a first input element, a first output element, a first reference element. The primary side is configured to receive a first input voltage at the first input element, a first secondary side, including a second input element, a second output element and a second reference element, wherein the first low side capacitor is positioned between the first reference element and the second reference element, wherein the first high side capacitor couples the first output element to the second input element. The system further comprises a second circuit, including: a second high side capacitor and a second low side capacitor, a second primary side including a third input element, a third output element, a third reference element. The second primary side is configured to receive a second input voltage at the third input element, a second secondary side, including a fourth input element, and a fourth output element. The second low side capacitor is positioned between the third reference element to the second reference element. The second high side capacitor couples the third output element to the fourth input element, and the second output element is connected to the fourth output element. The first circuit and the second circuit are configured to convert power across the first circuit and the second circuit, the first input element is connected to the third reference element, and the second low side capacitor is configured to clamp the second input voltage to the first input voltage.

In another example, the disclosure is directed to a method comprising: receiving, by a circuit, an input voltage applied between an input element of the circuit and a first reference element of the circuit, supplying, by the circuit, an output voltage between an output element of the circuit and a second reference element of the circuit. The first reference element and the second reference element are electrically connected by a low side capacitor configured to isolate the first reference element from the second reference element, and coupling, by the circuit, power from the input element to the output element via a coupling capacitor.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example power converter for connecting two different voltage domains, according to one or more techniques of this disclosure.

FIG. 2 is a block diagram illustrating an example stacked, modular, isolated power converter for connecting two different voltage domains, according to one or more techniques of this disclosure.

FIG. 3 is a schematic diagram illustrating an example implementation of an isolated power converter circuit with capacitive isolation, according to one or more techniques of this disclosure.

FIGS. 4A and 4B are schematic diagrams illustrating a charging and discharging phase of an illustrating of an example implementation of an isolated Zeta power converter circuit according to one or more techniques of this disclosure.

FIGS. 5A-5E are time graphs illustrating the charging and discharging phase of one example implementation of an isolated Zeta power converter circuit according to one or more techniques of this disclosure.

FIG. 6A is a time graph illustrating the voltages and currents during start-up of one example implementation of an isolated Zeta power converter circuit according to one or more techniques of this disclosure.

FIG. 6B is a time graph illustrating the voltages and currents during steady state of one example implementation of an isolated Zeta power converter circuit according to one or more techniques of this disclosure.

FIG. 6C is a time graph illustrating an example operation of a three stage power converter according to one or more techniques of this disclosure.

FIG. 7 is a schematic diagram illustrating an isolated power converter of this disclosure arranged in a combination of stacked and interleaved configuration.

FIG. 8A is a schematic diagram illustrating a second example of an interleaved arrangement of a power converter circuit of this disclosure.

FIG. 8B is a time graph illustrating the performance of the interleaved arrangement of FIG. 8A.

FIG. 9 is a flow diagram illustrating an example operation of the power converter according to one or more techniques of this disclosure.

### DETAILED DESCRIPTION

This disclosure describes techniques for power conversion between two different voltage domains using a power conversion system based on isolated versions of converter topologies, such as Cük, SEPIC, Zeta, or their variants. This disclosure describes the addition of isolation components, such as capacitors or level shifters, to converter topologies. The power conversion system includes multiple isolated power converters which may be interconnected in a stacked or interleaved configuration.

The first domain of the two domains may comprise an input power supply, which is the energy source for the system. The second domain is connected to the output, which may include a load that uses power from the power conversion system. The domains on each side of the power conversion system may have different voltages ratings and may also have different characteristics (DC or AC). Input supply and output load may also present different types of interconnections, e.g. stacked connection of multiple cells, parallel connection of multiple cells, and similar interconnections. Splitting the power of the output load into multiphase or multi-modular converters provides a solution for high power conversions.

The power conversion system of this disclosure may be configured to boost the power capability in order to supply a high load demand within the limitation of power switches and passive components that can limit the amount of power that can transferred from the input supply to the load. The power converter of this disclosure may increase power density of the multiphase systems, with the modular approach. The modular approach of this disclosure splits the total load current among all the modules and splits the semiconductor voltage ratings in the input cell voltage levels. Modifying power converter topologies to create isolated power converters, allows the power converters to have stacked or interleaved input supply interconnection without the risk of short-circuits that may be found with non-isolated power converters.

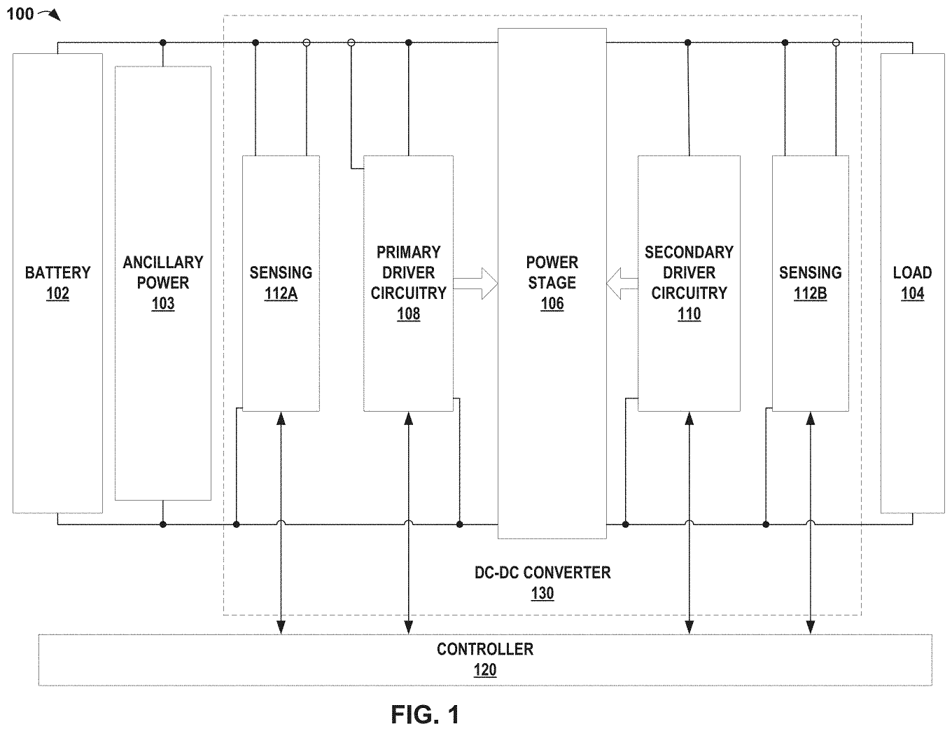

FIG. 1 is a block diagram illustrating an example power converter for connecting two different voltage domains, according to one or more techniques of this disclosure. Power converter 100 may also be referred to as a power conversion system in this disclosure.

In the example of FIG. 1, power converter 100 (system 100, for short), includes controller 120, DC-DC converter 130, an input domain which may include battery 102 and ancillary power supply 103, and an output domain which may include load 104. The magnitude of voltage of the input domain may be the same as the voltage at the output domain. In other examples, the magnitude of voltage of the input domain may be greater than or less than the magnitude of voltage of the output domain. In some examples, one or more drive signals from controller 120 may be configured to change a first magnitude of the input voltage to a second magnitude of the output voltage, where the first magnitude is different from the second magnitude.

DC-DC converter 130 may be implemented using any one of several topologies. In the example of FIG. 1, DC-DC converter 130 includes power stage 106, primary driver circuitry 108, secondary driver circuitry 110, sensing circuitry 112A on the primary side and sensing circuitry 112B on the secondary side. Power stage 106, primary driver circuitry 108 and secondary driver circuitry 110 may include isolation features, such as capacitors, level shifters or similar techniques (not shown in FIG. 1) to isolate the input domain from the output domain. In addition, components of DC-DC converter 130 may include protection circuitry such as overvoltage, overcurrent, over-temperature disconnection switches and other similar protection features (not shown in FIG. 1).

Primary driver circuitry 108 and secondary driver circuitry 110 may include circuitry, such as amplifiers, filters, and similar circuitry to drive components of power stage 106. Signals from primary driver circuitry 108 and secondary driver circuitry 110, may drive a control terminal of a power switch, such as the gate of a metal oxide semiconductor field effect transistor (MOSFET), an insulated gate bipolar transistor (IGBT) or other control terminal for other types of power switches including. In other examples, signals from controller 120 may directly drive components of power stage 106. In some examples, such as for a zeta converter, the power switch may be placed on the negative supply rail, which may remove the need for level shifter circuitry. In other words, a level shifter may not be tied to ground in some examples. Some examples of DC-DC converter 130 may not need an isolated gate driver.

System 100 may include one or more ancillary power supplies, such as ancillary power supply 103, which may be included to boost the primary side. In other examples, other uses for an ancillary power supply may include as synchronous rectification gate driver IC (secondary side) and sensing supply from control circuitry in controller 120. In some examples, ancillary power supplies may be included on the secondary side or may be connected in other locations (not shown in FIG. 1). In some examples, battery 102 may be implemented using multiple stacked battery cells to achieve a desired output voltage.

Sensing circuitry 112A and 112B may include components and circuitry to measure voltage, current, temperature, and other characteristics of DC-DC converter 130. Sensing circuitry 112A and 112B may receive commands from controller circuitry 120 and may send signals indicating values of characteristics sensed by sensing circuitry 112A and 112B.

Controller 120 may be configured to communicate sensing circuitry 112A and 11B as well as primary driver circuitry 108 and secondary driver circuitry 110. In some examples, drive signals from controller 120 may cause power to be transferred from the output domain to the input domain. Though the term “load” may be interpreted as drawing power from a supply, in some examples load 104 may be configured to provide power to, for example battery 102. As one example, a 12 V power socket in an automobile may be normally considered to supply power to a load, such as an electrically powered appliance. However, in some examples an appliance or device, such as an automobile battery charger, may be plugged into the 12V power socket and used to charge an automobile battery. In this manner, the 12V power socket “load” supplies power to the automobile battery, which, in normal operation, may be the power supply for the 12V power socket. Similarly, drive signals from controller 120 may cause power to be transferred from load 104 to the input domain, e.g. ancillary power supply 103 and/or battery 102.

In one or more examples, the functions described above may be implemented in hardware, software, firmware, or any combination thereof. For example, the various components, such as controller 120 of FIG. 1 may be implemented in hardware, software, firmware, or any combination thereof. If implemented in software, the functions may be stored on a tangible computer-readable storage medium and executed by a processor or hardware-based processing unit.

Instructions may be executed by one or more processors, such as one or more DSPs, general purpose microprocessors, ASICs, FPGAs, or other equivalent integrated or discrete logic circuitry. Accordingly, the terms “processing circuitry” or “processor,” as used herein, may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described

A power converter system according to the techniques of this disclosure may provide several advantages over other types of power converters. The modular approach of splitting the power of the output load into multiphase or multi-modular converters may provide high power conversion, while at the same time splits the total load current among all the modules. The modular approach may also split the semiconductor voltage ratings of the circuitry of DC-DC converter 130 by reducing input cell voltage levels. Lower voltage rating components may result in lower cost power converters.

Selecting the power converter topology may also provide advantages. Some examples of modular approach that splits the input and the output may include a transformer for each stage. A transformer may provide galvanic isolation but may be costly, bulky and heavy when compared to the techniques of this disclosure. For example, the isolated power converter of this disclosure may use half of the amount of semiconductors and it does not require a high frequency transformer.

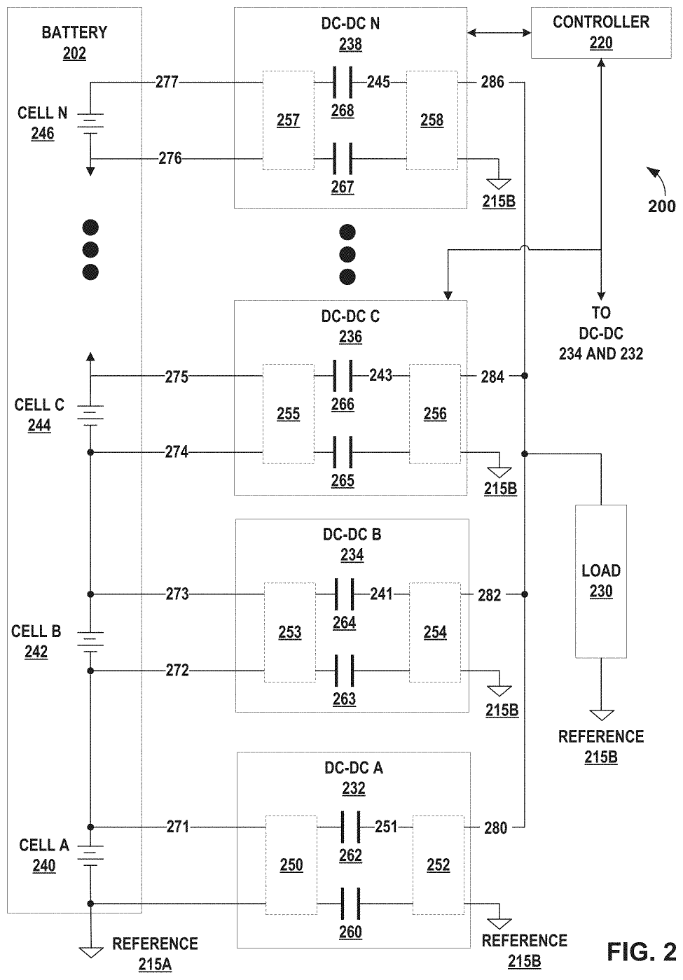

FIG. 2 is a block diagram illustrating an example stacked, modular, isolated power converter for connecting two different voltage domains, according to one or more techniques of this disclosure. Power converter system 200 is an example of power converter system 100 described above in relation to FIG. 1.

The example of system 200 includes N power converters interconnected in a stacked arrangement. In other examples, the N power converters of system 200 may be connected in an interleaved arrangement (not shown in FIG. 2). As with system 100 of FIG. 1, system 200 includes an input domain which may include battery 202 and an ancillary power supply (not shown in FIG. 2). System 200 may also include an output domain which may include load 230. The magnitude of voltage of the input domain may be the same, greater or less than the voltage at the output domain.

System 200 may also include controller 220, which is an example of controller 120 described above in relation to FIG. 1 and may include the same functions and characteristics as controller 120. Controller 220 may send control signals to the N power converters and receive status and sensor signals from each power converter. The example of FIG. 2 depicts control signals from controller 220 as connected to each power converter (DC-DC A 232 through DC-DC N 238) in parallel. In other examples, controller 220 may connect to a first power converter, e.g. DC-DC N 238, and signals may pass through the first power converter and through each of the other power converters in series (not shown in FIG. 2).

The example of FIG. 2 depicts load 230 as a single load supplied by each of the N power converters. In other examples, load 230 may be implemented as several different loads, with each of the different loads supplied by a single power converter, e.g. DC-DC B 234 (not shown in FIG. 2). In other words, system 200 may be configured to output a power distribution from output elements 282, 284, 286 and 288 with up to N different output voltages. In other examples, the different loads may be supplied by groups of power converters, e.g. DC-DC A 232 and DC-DC B 234 may supply a first load, while DC-DC C 236 supplies a second load, and so on (not shown in FIG. 2). Examples of load 230, or other loads that may be part of system 200 may include a battery, a motor, lighting, control electronics and other similar loads.

In the example of FIG. 2, battery 202 is a multi-cell battery including cell A 240, cell B 242, cell C 244 through cell N 246. The power converters of system 200 connect across each cell of battery 202, according to the modular approach of this disclosure. In other words, the input element and reference element of each power converter connect across the positive and negative terminals, respectively, of each cell of battery 202. In this manner, system 200 splits the power of from the input to the output into multi-modular converters. The modular approach of system 200 therefore splits the total load current among all the modules and splits the semiconductor voltage ratings for components in each DC-DC converter module. The power converter topologies, which include a low side capacitor, or a level shifter in some examples, may create isolated power converters, which allows the power converter modules to have stacked or interleaved input supply interconnection without the risk of short-circuits that may be found with non-isolated power converters.

System 200 may include a first circuit, e.g., power converter DC-DC A 232. DC-DC A 232 may include a first high side capacitor 262 and a first low side capacitor 260 arranged to isolate a first primary side 250 from a first secondary side 252. Although depicted as a single capacitor in the example of FIG. 2, in other examples, any of the capacitors in FIG. 2 may be implemented as multiple capacitors in parallel and in series. The capacitor arrangement, e.g. parallel or series, may be based on the isolation and protection functions as well as other performance functions for each power converter. In other examples, capacitor 260, or any other capacitor in FIG. 2, may be implemented as a level shifter.

Primary side 250 may include input element 271 and a first output element, which connects to a first terminal of high side capacitor 262, and a first reference element, which connects to reference voltage 215A. Primary side 250 may be configured to receive a first input voltage from Cell A 240 at first input element 271.

Secondary side 252 of DC-DC 232 A, may include a second input element 251 connected to the opposite terminal of capacitor 262 from the output element of primary side 250. In other words, the first high side capacitor 262 couples the first output element to the second input element 251. Secondary side 252 may also have a second output element 280 and a second reference element which connects to a second reference voltage 215B.

In the Example of FIG. 2, the first low side capacitor 260 is positioned between the first reference element of primary side 250 and the second reference element of secondary side 252. Low side capacitor 260 may provide capacitive isolation between primary side 250 and secondary side 252. In some examples, low side capacitor 260 may be electrically connected in series between the first reference element of primary side 250 and the second reference element of secondary side 252.

In the example of FIG. 2, the reference element is a terminal of the circuit, e.g. of secondary side 252, primary side 250, secondary side 254, and so on. The reference elements may electrically connect to one of the reference voltages 215A and 215B. In some examples, reference voltages 215A and 215B are separate reference voltages. In other examples, reference voltages 215A and 215B are electrically connected and at the same voltage potential. When reference voltages 215A and 215B are electrically connected, low side capacitor 260 may not provide isolation between primary side 250 and secondary side 252. However, low side capacitor 260 may still provide a useful protection function, if for example there is a fault in circuitry connected to either reference voltage 215A or 215B, or if the connection between reference voltages 215A and 215B is disconnected.

To simplify the description, in this disclosure a “terminal” may describe an electrical connection points for a capacitor and a battery cell. An “element” may describe an electrical connection to other connection points on a circuit. However, the terms are interchangeable in this disclosure. For example, an input element and an input terminal may be the same type of electrical connection.

System 200 also includes a second circuit, DC-DC B 234, which, like DC-DC A 232 includes high side capacitor 264 and low side capacitor 263. The primary side 253 of DC-DC B 234 may include a third input element 273, a third output element and a third reference element 272. Primary side 253 is configured to receive a second input voltage from cell B 242 at the third input element 273. Secondary side 254 of DC-DC B 234 may include a fourth input element 241, and a fourth output element 282. In system 200, the second output element 280 for secondary side 252 is connected to the fourth output element 282 for secondary side 254 and may be electrically connected to load 230. As described above, output elements 282 and 280 may either provide power to load 230 or in other examples, may receive power to be transferred to the input elements 273 and 271.

Each high side capacitor and low side capacitor each power converter circuit may form a capacitive divider. In some examples, high side capacitor 264 has approximately the same characteristics to low side capacitor 263. Some examples of characteristics may include capacitance, voltage rating, leakage rating, and capacitor type, e.g. ceramic, tantalum, or formed as part of an integrated circuit. In other examples, one or more characteristics of high side capacitor 264, such as capacitance, may differ from low side capacitor 263. In some examples, the characteristics for capacitors may differ between each power converter circuit, while in other examples, some capacitor characteristic may be approximately the same between power converter circuits. In the context of this disclosure, “approximately the same” means the equal, within manufacturing and measurement tolerances.

First input element 271 for primary side 250 is connected to the third reference element 272 for primary side 253 of DC-DC B 234. A second high side capacitor 264 couples the third output element from primary side 253 to the fourth input element 241 of secondary side 254. In some examples, e.g. for a modular converter circuit configured with a Zeta topology, the high side capacitor may be configured to operate as a flying capacitor.

Low side capacitor 263 is positioned between the third reference element 272 and the reference element of secondary side 254, which is connected to reference voltage 215B. As with low side capacitor 260 of DC-DC A 232, low side capacitor 263 may provide capacitive isolation between primary side 253 and secondary side 254. Low side capacitor 263 may be electrically connected in series between reference element 272 of primary side 253 and the reference element of secondary side 254. Low side capacitor 263 may clamp the voltage from cell A 240 at reference element 272.

First circuit DC-DC A 232 and second circuit DC-DC B 234 are configured to convert power across DC-DC A 232 and DC-DC B 234. In some examples, as described above, DC-DC A 232 and DC-DC B 234 may supply power to load 230, which may be coupled between output elements 280 and 282 and reference voltage 215B. Also, as described above in relation to FIG. 1, in some examples, controller 220 may output signals to cause power to be supplied from the “output domain” to the “input domain,” such as to charge battery 202. In other words, controller 220 may cause the first circuit, DC-DC A 232 and the second circuit DC-DC B 234 to transfer power from the secondary side output elements 280 and 282 to the first input element 271 and the third input element 273. The remaining DC-DC converter circuits in system 200, e.g. DC-DC C 236 through DC-DC N 238 may also be configured to convert power across the DC-DC converter circuits in either direction.

As described above in relation to sensing circuitry 112A and 112B of FIG. 1, one or more modular converter circuits may include sensing circuitry (not shown in FIG. 2). Sensing circuitry may be operatively coupled to controller 220. The sensing circuitry may be configured to monitor one or more parameters one or more modular converter circuits of system 200 and communicate the status of the one or more parameters to the controller. Some example parameters may include the input voltage for a cell of battery 202, current transferred from an output element, discharge rate, charging rate, temperature of one or more portions of the power converter circuit, and similar parameters. In some examples, cell voltage may be used to determine cell discharge level.

Similar to the second converter circuit module, DC-DC B 234, converter circuit module DC-DC C 236 includes high side capacitor 266 and low side capacitor 263. The primary side 255 of DC-DC C 236 may include input element 275, an output element connected to high side capacitor 266, and reference element 274. Primary side 255 is configured to receive an input voltage from cell C 244 at input element 273. Secondary side 256 of DC-DC C 236 may include input element 243, which is connected to the output element of primary side 255 through high side capacitor 266. Output element 284 of secondary side 256 may be electrically connected to load 230, as well as output elements 286, 282 and 280, as shown in the example of FIG. 2. Reference element 274 is also connected to input element 273 and the positive terminal of cell B 242.

Low side capacitor 265 is positioned between reference element 274 and the reference element for secondary side 256. The reference element for secondary side 256 is connected to reference voltage 215B, and therefore, in some examples, may be electrically connected to reference voltage 215A.

As with low side capacitor 263 of DC-DC B 234, low side capacitor 265 may provide capacitive isolation between primary side 255 and secondary side 256. Low side capacitor 265 may be electrically connected in series between reference element 274 of primary side 255 and the reference element of secondary side 256. Similar to capacitor 263, low side capacitor 263 may clamp the voltage from cell B 242 at reference element 274. In other words, low side capacitor 265 may clamp the voltage at reference element 274 to be the sum of all battery cells stacked below cell C 244. In the example of FIG. 2, low side capacitor 265 may clamp the sum of the voltages for cell B 242 and cell A 240.

Similarly, a low side capacitor for the next converter circuit module stacked in sequence above DC-DC C 236 (not shown in FIG. 2), would clamp the voltage for the sum of the voltages on cell A 240, cell B 242 and cell C 244, as well as providing capacitive isolation between the primary side and the secondary side of the next converter in the stack. In this manner, the topology of the converter circuit modules of this disclosure with the additional isolation and clamping features provided, for example, by the low side capacitors, allows the converter circuit modules to be stacked to split the current and voltage ratings among the modules.

Converter circuit module DC-DC N 238 functions similar to DC-DC C 236 and DC-DC B 234. Specifically, DC-DC N 238 may include high side capacitor 268 and low side capacitor 267. Primary side 257 of DC-DC C 238 may include input element 277, an output element connected to high side capacitor 268, and reference element 276. Primary side 257 is configured to receive an input voltage from Cell N 246 at input element 277. Secondary side 258 of DC-DC N 238 may include input element 245, connected to the output element of primary side 257 through high side capacitor 268. Output element 286 of secondary side 258 may be electrically connected to load 230, as well as output elements 284, 282 and 280. Reference element 276 is also connected to an input element of cell N−1 (not shown in FIG. 2) and the negative terminal of cell N 246.

Low side capacitor 265 is positioned between reference element 276 and the reference element for secondary side 258, which is connected to reference voltage 215B.

As with low side capacitor 263 of DC-DC B 234, low side capacitor 267 may provide capacitive isolation between primary side 257 and secondary side 258. Similar to capacitor 265, low side capacitor 267 may clamp the voltage at reference element 276 as the sum from all cells N−1 and below. In other words, low side capacitor 267 is configured to clamp the voltage at input element 277 to the sum of N−1 input voltages between the reference element 276 and the first reference voltage, e.g. reference voltage 215A.

As described above, in some examples, reference voltages 215A and 215 B may be connected together. When 215A and 215B are electrically connected, then capacitor 260, for DC-DC A 232, does not provide capacitive isolation. However, capacitors 263, 265 and so on up to capacitor 268 of DC-DC N 238, continue to act as low-side capacitors to isolate the primary side reference element from the secondary side reference element, even when 215A and 215B are electrically connected.

The arrangement of the converter circuits in the example of FIG. 2, may provide several advantages over other types of circuits. For example, the arrangement of system 200 provides redundancy and functional safety should one of the cells of battery 202 be lost, as a result of open circuit, short circuit, or otherwise disabled. The remaining cells and converter circuits will continue to function, providing isolation and power conversion, even though, for example, cell C 244 is not available.

The arrangement of the converter circuits in the example of FIG. 2, may provide an additional feature of protection from a short circuit on the load side or the battery side. For example, capacitors 265 and 266 may protect cell C 244 from an inadvertent short circuit between output element 282 and reference 215B. The short circuit self-protection feature may also function in an interleaved arrangement (not shown in FIG. 2), as well as the stacked arrangement depicted in FIG. 2.

The modular approach of system 200 may also provide for cell balancing of battery 202. For example, controller 220 may determine that one or more battery cells has a different discharge level than other battery cells. Controller 220 may adjust the operation of the modular power converter circuits to balance the discharge level of the battery cells of battery 202. As one example, based on signals from one or more sensors associated with DC-DC B 234 (not shown in FIG. 2), controller 220 may determine that the discharge level of cell B 242 may be different than other cells of battery 202. For example, the discharge level of cell B 242 may be greater than a threshold difference from the median or average discharge level of the other cells. Controller 220 may adjust the control signals to DC-DC B 234 to draw less power from cell B 242 until the discharge level of cell B 242 is balanced with the remaining cells of battery 202. Similarly, when charging battery 202, controller 220 may manage the charging rate of each modular power converter circuit to keep the charge levels of the battery cells within balance.

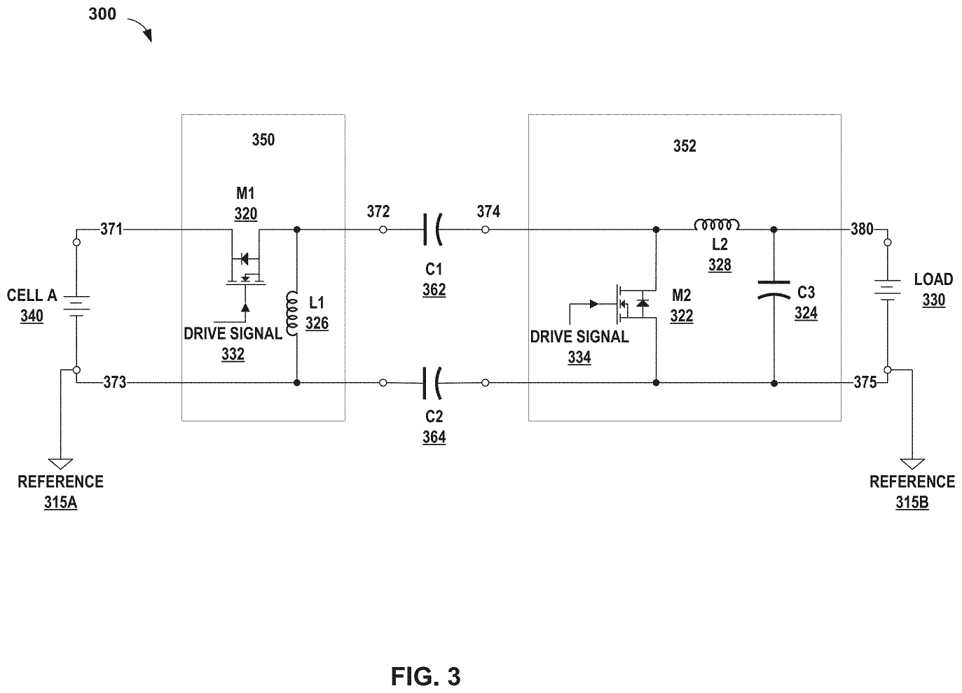

FIG. 3 is a schematic diagram illustrating an example implementation of an isolated power converter circuit with capacitive isolation, according to one or more techniques of this disclosure. Circuit 300 is an example implementation of any of converter circuit modules DC-DC A 232-DC-DC N 238 described above in relation to FIG. 2. Circuit 300 in the example of FIG. 3 is implemented as a Zeta topology, with the additional isolation provided by low side capacitor C2 364. In other examples, circuit 300 may be implemented as other isolated topologies, such as Sepic, Cük, or other related topologies. In the example of circuit 300, when power is converted from cell A 340 to output element 380 connected to load 330, circuit 300 operates in the Zeta configuration. In the example in which power is converted in the opposite direction from “output” terminal 380 to “input” terminal 371, circuit 300 may be considered to operate in the Sepic configuration.

In the example of FIG. 3, circuit 300 includes primary side 350, secondary side 352, high side capacitor C1 362 and a low side capacitor C2 364. Primary side 350 includes first input element 371, first output element 372, first reference element 373 connected to reference voltage 315A. Primary side 350 is configured to receive an input voltage from cell A 340 at first input element 371.

Circuit 300 also includes secondary side 352, with second input element 374, second output element 380 and second reference element 375 connected to reference voltage 315B. Low side capacitor C2 364 is positioned between first reference element 373 and second reference element 375. In the example of circuit 300, capacitor C2 364 is connected in series between first reference element 373 and second reference element 375. In other examples . . . As described above in relation to FIG. 2, in other examples the isolation and protection functions of low side capacitor C2 364 may be provided by a level shifter. High side capacitor C1 362 couples first output element 372 to second input element 374.

Primary side 350 includes an N-channel MOSFET M1 320 and inductor L1 326. The drain of M1 320 acts as first input element 371 and the source of M1 acts as first output element 372. Inductor L1 326 is positioned in series between first output element 372 and first reference element 373, which is connected to one terminal of low side capacitor C2 364. The gate of M1 320 is configured to receive drive signal 332. In some examples, drive signal 332 may come from control circuitry, such as controller 120 and controller 220 described above in relation to FIGS. 1 and 2. In other examples, drive signal 332 may come from driver circuitry, such as primary driver circuitry 108 depicted in FIG. 1.

Secondary side 352 includes N-channel MOSFET M2 322, inductor L2 328, and third capacitor C3 324. The drain of M2 322 connects to second input element 374, while the source of MOSFET M2 322 connects to second reference element 375. Inductor L2 328 is positioned in series between second input element 374 and second output element 380, which is connected to load 330. Capacitor C3 324 is positioned in series between second output element 380 and second reference element 375.

MOSFET M2 322 receives drive signal 334 at the gate of M2 322. Although depicted as a MOSFET in the example of circuit 300, in other examples, MOSFET M1 320 and MOSFET M2 322 may be replaced by other types of power switches, such as a GaN switch, IGBT, or similar switch.

As described for reference voltages 215A and 215B above in relation to FIG. 2, in some examples, reference voltages 315A and 315B may be connected together, while in other examples reference voltage 315A may be isolated from 315B. When reference voltages 315A and 315B are connected together, low side capacitor C2 364 may provide a protection function in case of a fault. When reference voltage 315A is isolated from 315B, low side capacitor provides both isolation and protection functions. Examples of reference voltage 315A isolated from 315B is depicted in the examples of DC-DC converters DC-DC B 234-DC-DC N 238 described above in relation to FIG. 2 in which the low side capacitor isolates the primary side reference terminal from the secondary side reference terminal.

In the example of circuit 300, primary side 350 and secondary side 352 form a converter with Zeta topology. Output element 380 in the Zeta topology of circuit 300 may be considered a floating output. In other examples, primary side 350 and secondary side 352 may be rearranged to form a Sepic topology (not shown in FIG. 3). Similarly, the primary side and secondary side of DC-DC converters DC-DC A 232-DC-DC N 238 described above in relation to FIG. 2 may be arranged as a Zeta, Sepic, Ca or similar topology.

The arrangement of the secondary side 352 of circuit 300 may provide a redundancy and availability features. For example, switch M2 322 could be used as a bypass switch in the case of a fault with a converter, such as the converter arrangement in system 100 described above in relation to FIG. 2. For example, closing switch M2 322 could bypass cell A 340 in an example in which cell A 340 malfunctions or becomes damaged. Therefore, a system that includes power converter circuit 300 may save the cost and complexity of providing a separate bypass switch for each cell in the battery array.

When compared to other topologies, such as for example a multiphase solution utilizing a buck converter, the Zeta circuitry has also only two switches in the bill of materials. Also, the buck converter is not isolated and could not be stacked, as shown for example in system 200 described above in relation to FIG. 2.

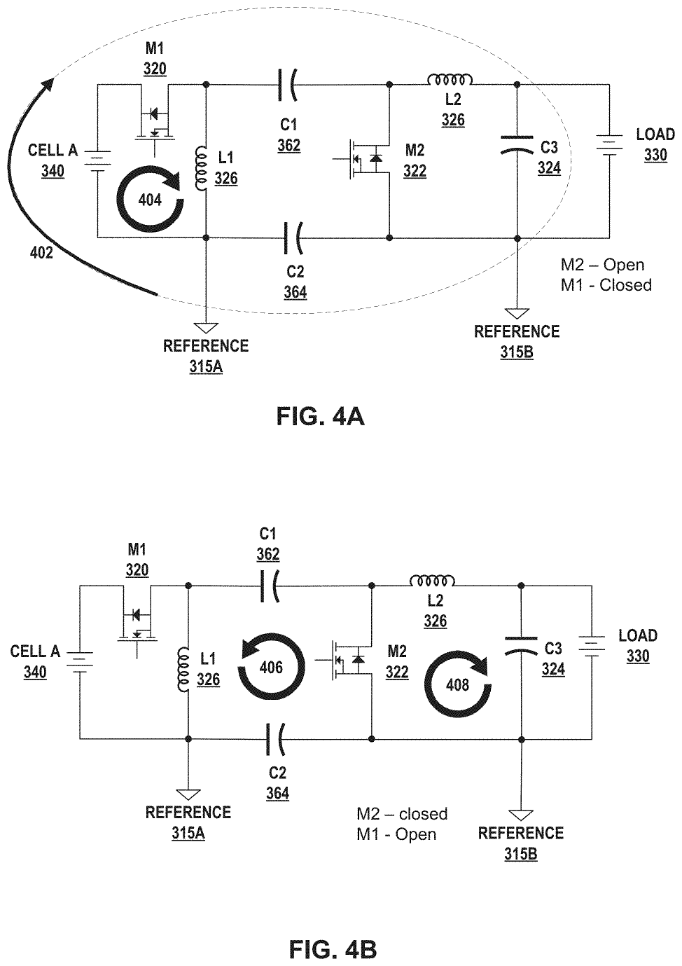

FIGS. 4A and 4B are schematic diagrams illustrating a charging and discharging phase of an illustrating of an example implementation of an isolated Zeta power converter circuit according to one or more techniques of this disclosure. The circuits of FIGS. 4A and 4B are an example of circuit 300 described above in relation to FIG. 3. FIG. 4A depicts the discharging phase, in which MOSFET M2 322 is open and MOSFET M1 320 is closed. During the discharging phase, a first current 404 flows from the positive terminal of cell A 340 in a loop formed by MOSFET M1 320, through inductor L1 326 and to the negative terminal of cell A 340. A second current 402 flows from the positive terminal of cell A 340 in a loop formed by MOSFET M1 320, through high side capacitor C1 362, inductor L2 326, capacitor C3 324, low side capacitor C2 364 and to the negative terminal of cell A 340.

FIG. 4B depicts the charging phase, in which MOSFET M2 322 is closed and MOSFET M1 320 is open. During the charging phase, a first current 406 flows in a loop formed by M2 322, to C1 362, L1 326, and C2 364. Also, a second current 408 flows in a loop formed by M2 322, L2 326, and C3 324.

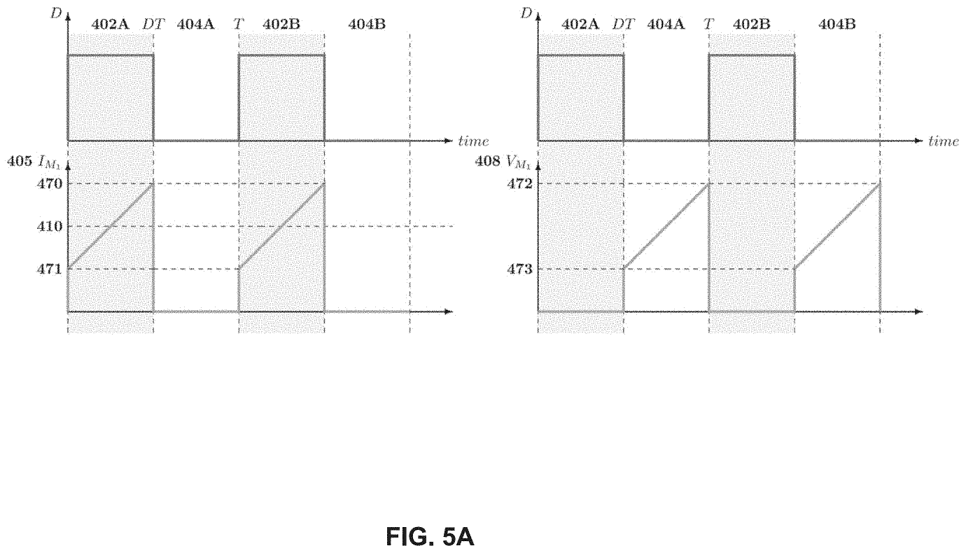

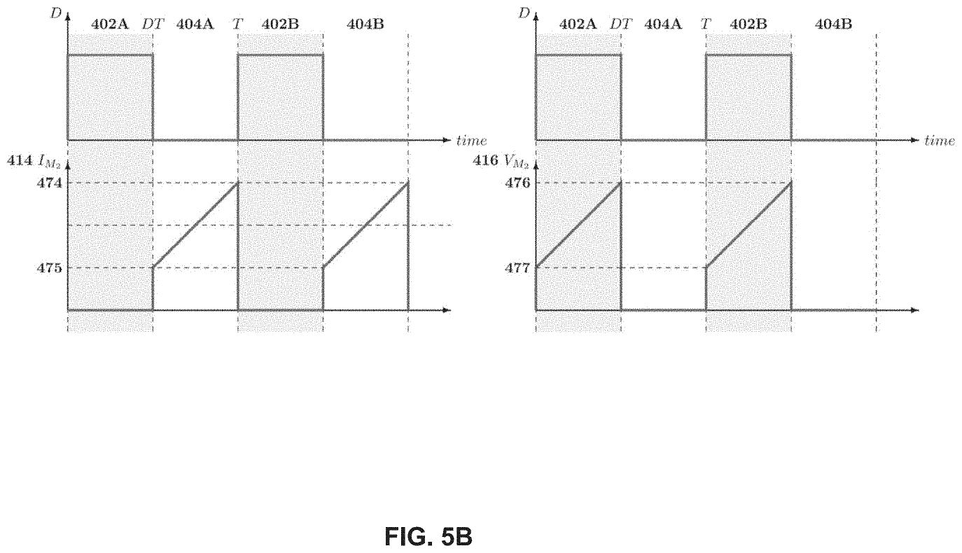

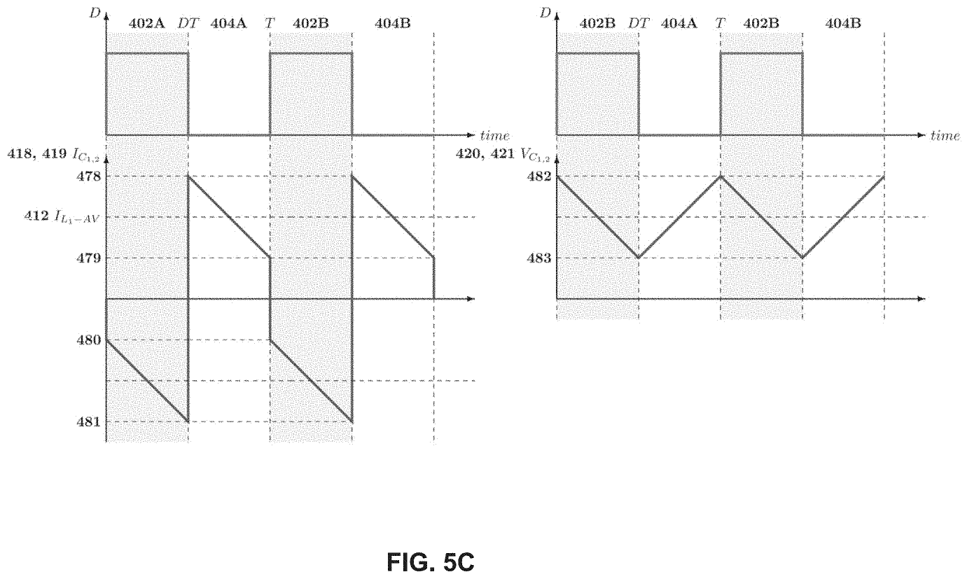

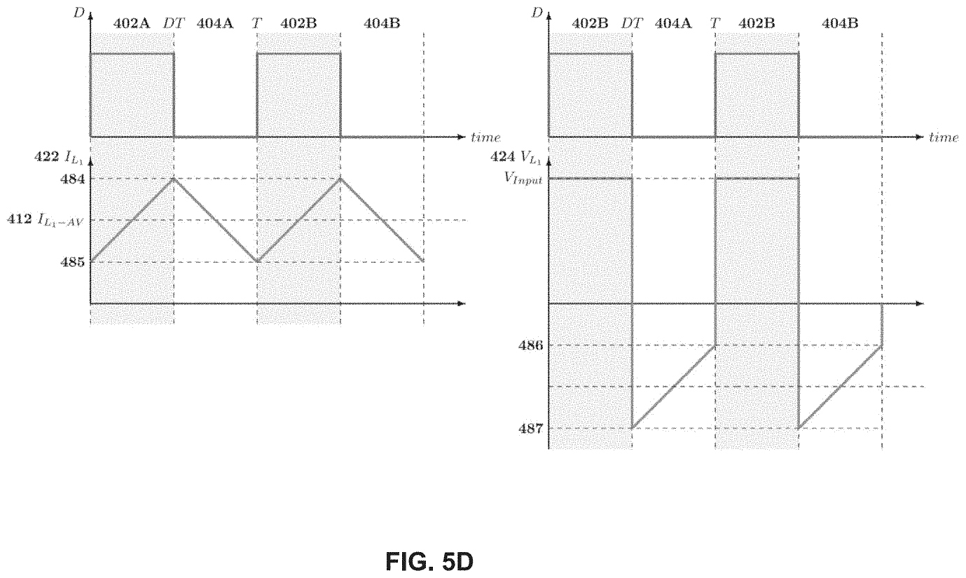

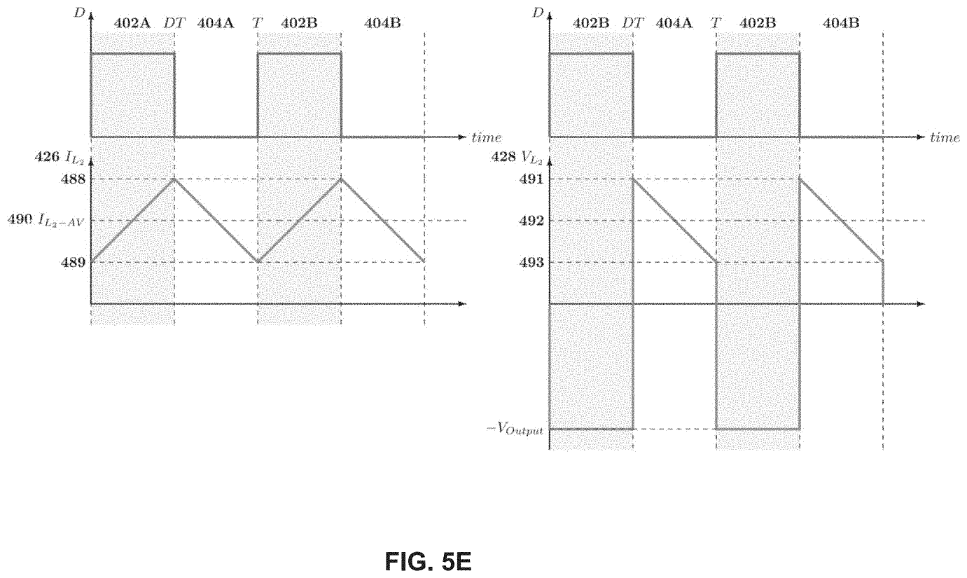

FIGS. 5A-5E are time graphs illustrating the charging and discharging phase of one example implementation of an isolated Zeta power converter circuit according to one or more techniques of this disclosure. The example of FIGS. 5A-5E illustrate example behavior of various voltages and currents in a circuit, such as circuit 300 described above in relation to FIG. 3, over two charging and discharging cycles. The components described in FIGS. 5A-5E are the same components depicted in circuit 300. Note that for other circuit implementations, the specific behavior described in FIGS. 5A-5E may vary from the details described below.

In FIG. 5A, the current through switch M1, I_{M1} 405 increases during the discharging phases 402A and 402B from less than Ioutput 410 to greater than Ioutput 410. In the example of FIG. 5A, switch current I_{M1} 405 ramps from I_{L1}+I_{L2}−ΔI_{L1}+ΔI_{L2}/2 (471) to I_{L1}+I_{L2}+ΔI_{L1}+ΔI_{L2}/2 (470). The voltage across switch M1, V_{M1} 408 increases during the charging phases 404A and 404B from

$$\begin{matrix}{V}_{input} + {V}_{output} - \frac{Δ {V}_{C 3}}{2} to & ( 473 ) \\ {V}_{input} + {V}_{output} + \frac{Δ {V}_{C 3}}{2} & ( 472 )\end{matrix}$$

while switch M1 is open, where Vinput in the example of FIG. 3 is the voltage across cell A 340 and Voutput is the voltage across load 330.

In FIG. 5B, the current through switch M2, I_{M2} 414 increases during the charging phases 404A and 404B. Similar to switch M1 described above in relation to FIG. 5A, in the example of FIG. 5B, switch current I_{M2} 414 ramps from

$$\begin{matrix}{I}_{L 1} + {I}_{L 2} - \frac{Δ {I}_{L 1} + Δ {I}_{L 2}}{2} to & ( 475 ) \\ {I}_{L 1} + {I}_{L 2} + \frac{Δ {I}_{L 1} + Δ {I}_{L 2}}{2} . & ( 474 )\end{matrix}$$

The voltage across switch M2, VM2 416 increases during the discharging phases 402A and 402B from

$$\begin{matrix}{V}_{input} + {V}_{output} - \frac{Δ {V}_{C 3}}{2} to & ( 477 ) \\ {V}_{input} + {V}_{output} + \frac{Δ {V}_{C 3}}{2} . & ( 476 )\end{matrix}$$

FIG. 5C illustrates that the current and voltage through the high side capacitor C1 and low side capacitor C2 are approximately the same in that current Ice 419 and Ici 418 ramp down during the discharging phase 402A from

$$\begin{matrix}- {I}_{L 1} + \frac{Δ {I}_{L 2}}{2} to & ( 480 ) \\ - {I}_{L 1} - \frac{Δ {I}_{L 2}}{2} . & ( 481 )\end{matrix}$$

Current I_{C2} 419 and I_{C1} 418 also ramp down during the charging phase, but from greater than the average input current I_{L1-av} 412,

$$\begin{matrix}{I}_{L 1} + \frac{Δ {I}_{L 2}}{2} , to & ( 478 ) \\ {I}_{L 1} - \frac{Δ {I}_{L 2}}{2} . & ( 479 )\end{matrix}$$

Voltages V_{C1} 420 and V_{C2} 421 ramp down during the discharging phases 402 A and 402B and ramp up during the charging phases 404A and 404B between

$$\begin{matrix}{V}_{C 1 , 2} + \frac{Δ {V}_{C 1 , 2}}{2} and & ( 482 ) \\ {V}_{C 1 , 2} - \frac{Δ {V}_{C 1 , 2}}{2} . & ( 483 )\end{matrix}$$

FIGS. 5D and 5E illustrate that the current through the inductor L1 and L2 are similar. Both of current I_{L1} 422 and I_{L2} 426 ramp up during the discharging phases 402A and 402B. I_{L1} ramps from

$${I}_{L 1} - \frac{Δ {I}_{L 1}}{2} , \qquad ( 485 )$$

less than I_{L1-av} 412 to

$${I}_{L 1} + \frac{Δ {I}_{L 1}}{2} , \qquad ( 484 )$$

while I_{L2} ramps from

$${I}_{L 2} - \frac{Δ {I}_{L 2}}{2} , \qquad ( 489 )$$

less than I_{L2-av} 490 to

$${I}_{L 2} + \frac{Δ {I}_{L 2}}{2} . \qquad ( 488 )$$

During the charging phases 404A and 404B, both of current I_{L1} 422 and I_{L2} 426 ramp down.

The voltage across L1, V_{L1} 424 is approximately the input voltage Vinput, during the discharging phases 402A and 402B and ramps from

$$\begin{matrix}- {V}_{C 1 , 2} + \frac{Δ {V}_{C 1 , 2}}{2} and & ( 486 ) \\ - {V}_{C 1 , 2} - \frac{Δ {V}_{C 1 , 2}}{2} & ( 487 )\end{matrix}$$

during the charging phases 404A and 404B. In contrast, V_{L2} 428 is approximately the output voltage Voutput, during the discharging phases 402A and 402B and ramps through Vᵢₙₚᵤₜ+V_{C1,2} (492) between

$$\begin{matrix}{V}_{input} + {V}_{C 1 , 2} + \frac{Δ {V}_{C 1 , 2}}{2} and & ( 491 ) \\ {V}_{input} + {V}_{C 1 , 2} - \frac{Δ {V}_{C 1 , 2}}{2} & ( 493 )\end{matrix}$$

during the charging phases 404A and 404B.

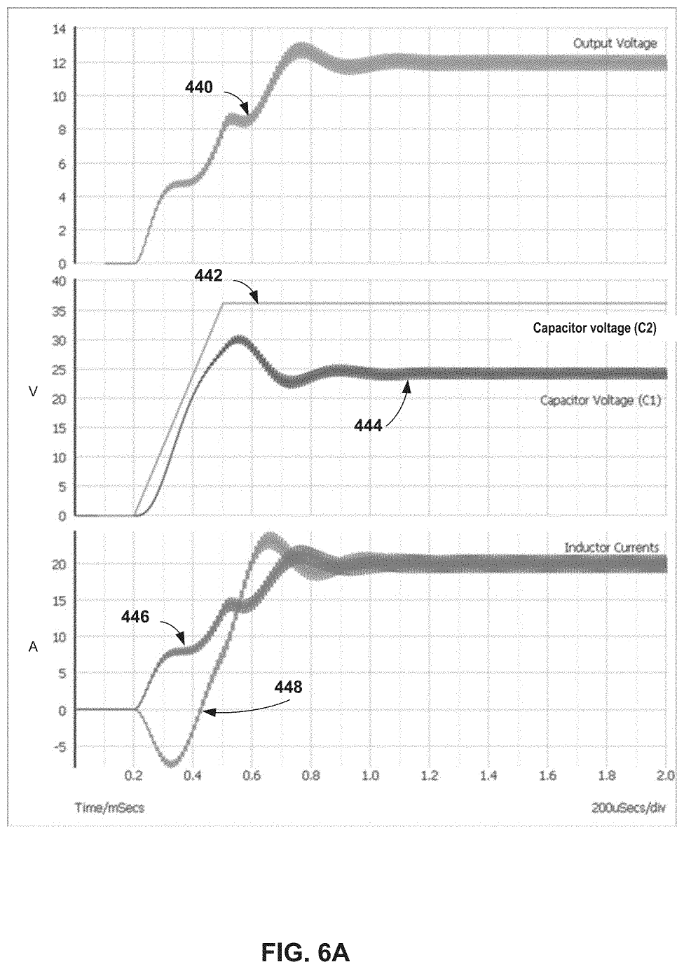

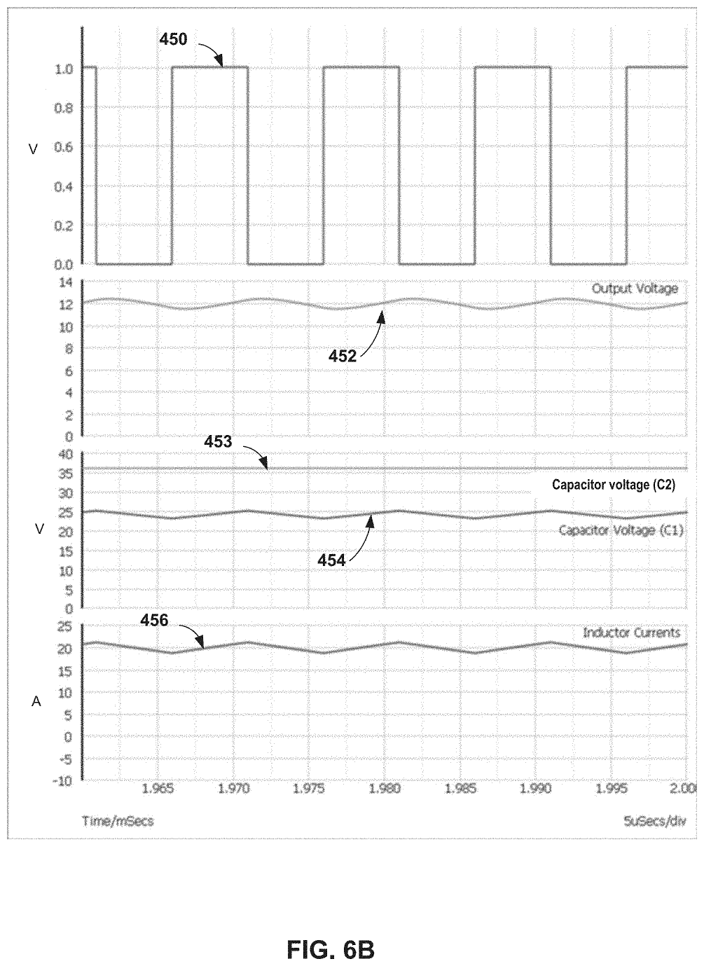

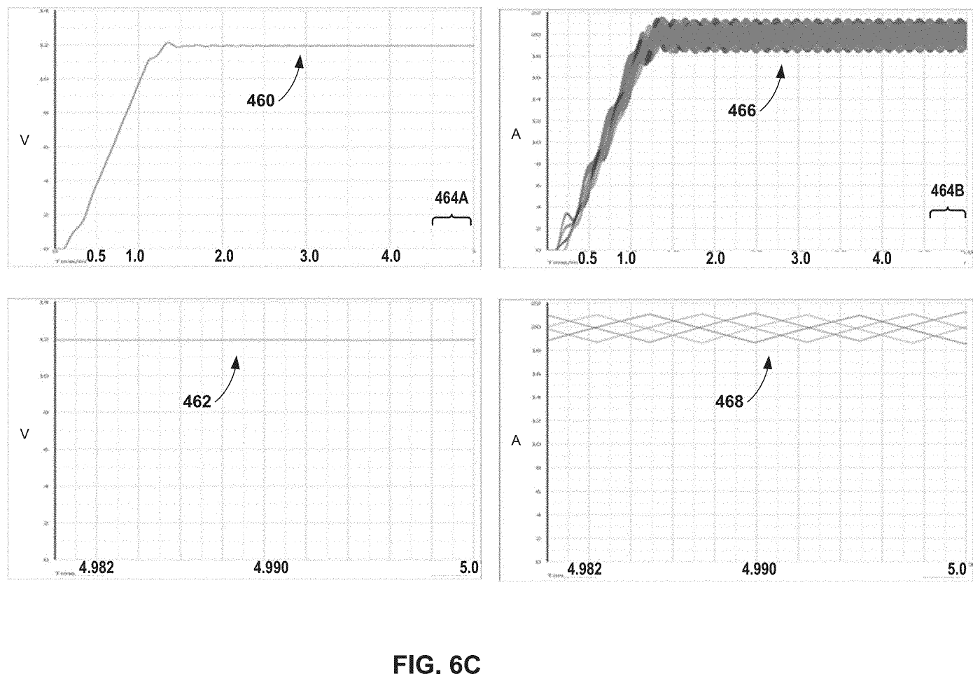

FIG. 6A is a time graph illustrating the voltages and currents during start-up of one example implementation of an isolated Zeta power converter circuit according to one or more techniques of this disclosure. The components described in FIG. 6A correspond to the components described above in relation to circuit 300 of FIG. 3. Graph 440 shows example behavior of the output voltage between reference terminal 375 and output element 380 during start-up. Graph 442 shows the voltage across low side capacitor C2 364 ramping up to an approximately constant voltage. As described above in relation to FIG. 2, low side capacitor C2 364 is configured to clamp the voltages for the DC-DC converter circuit modules lower in the stack. Graph 444 shows how the high side capacitor C1 362 has some overshoot before settling. Graph 448 shows the current through primary side inductor L1 326 and graph 446 shows the current through secondary side inductor L2 328.

FIG. 6B is a time graph illustrating the voltages and currents during steady state of one example implementation of an isolated Zeta power converter circuit according to one or more techniques of this disclosure. Graph 450 illustrates an example drive signal that may be delivered to switch M1, for example/gate-source voltage to MOSFET M1 320. Graph 452 shows the steady state output voltage. Graph 454 shows the voltage behavior of high side capacitor C1 362. Graph 453 shows how low side capacitor (C2) clamps the voltage of the reference terminal. Graph 456 shows the behavior of the inductor currents during steady state.

FIG. 6C is a time graph illustrating an example operation of a three-stage power converter according to one or more techniques of this disclosure. An example three stage power converter that may generate the time graph example of FIG. 6C may be seen in FIG. 2 as the arrangement of the three converter circuit modules DC-DC A 232, DC-DC B 234 and DC-DC C 236 connected to a single load, such as load 230.

Graph 460 shows the output voltage from start-up to steady state for the three-stage power converter. Graph 462 depicts a zoomed in view of graph 460 for the time duration indicated by 464A. Similarly, graph 466 shows the output current for each of the three converter circuit modules of the power converter from start up to steady state. Graph 468 shows a zoomed in view of graph 466 for the time duration indicated by 464B.

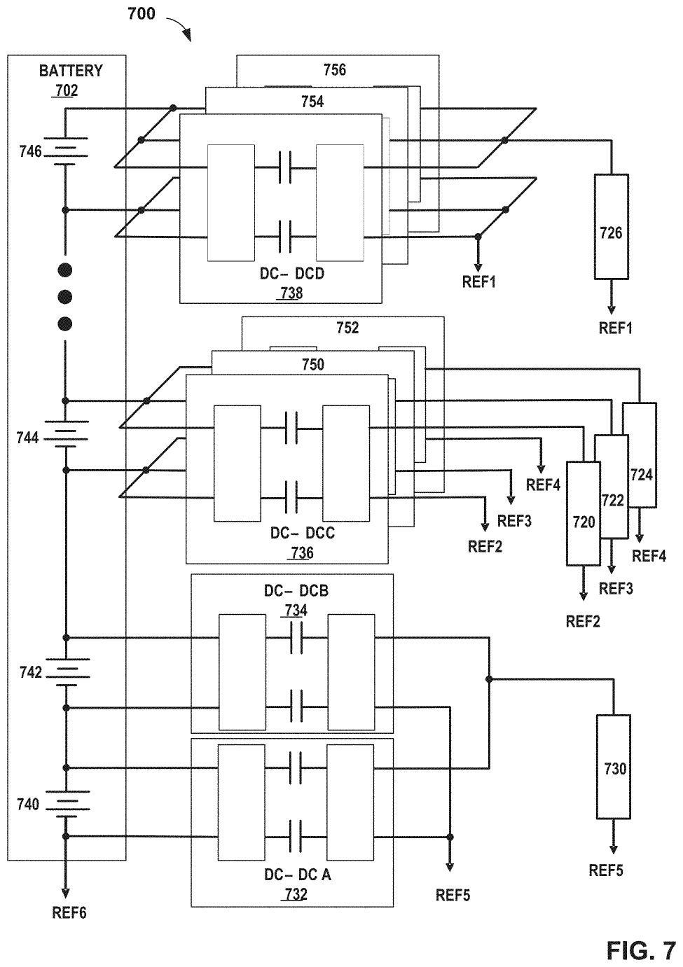

FIG. 7 is a schematic diagram illustrating an isolated power converter of this disclosure arranged in a combination of stacked and interleaved configuration. As described above in relation to FIG. 2, the example of FIG. 7 illustrates a few examples of how an isolated power converter of this disclosure may be configured. The example of battery 702, battery cells 740, 742, 744 and 746. loads 730, 720, 722, 724 and 726 and DC-DC converters, such as DC-DC A 732 depicted in FIG. 7 are examples of battery 202, battery cells 240, 242, 244 and 246, loads 230 and 330, and power converter circuits such as circuit 300, DC-DC A 232, and DC-DC converter 130 described above in relation to FIGS. 1-4B. The components of circuit 700 may have similar functions and characteristics to the components described above in relation to FIGS. 1-4B. For example, DC-DC power converter circuits 732, 734, 736, 738, 750, 752, 754, and 756 may be implemented as Zeta, Sepic, Cnk, or other related topologies and may convert power from one voltage level to another in either direction.

Similarly, each power converter circuit may include low side capacitor electrically connected in series between a reference element of a primary side and the reference element of secondary side of each power converter. The low side capacitor may provide capacitive isolation between primary side and secondary side. The low side capacitor may clamp the voltage from a stacked cell at the primary side reference element, as described above in relation to FIG. 2. For example, the low side capacitor for DC-DC B 734 may clamp the voltage from cell 740 at the primary side reference element for DC-DC B 734, which is also the negative terminal of cell 742. DC-DC A 732 and DC-DC B 734 are arranged in a stacked configuration and both DC-DC A 732 and DC-DC B 734 supply a single load 730, which is similar to the arrangement of circuit 200 described above in relation to FIG. 2.

Power converters 750, 752 and DC-DC C 736 are arranged in an interleaved configuration with each separate power converter supplying a separate load. DC-DC C 736 connects to load 720. Similarly, DC-DC power converters 750 and 752 connect to load 722 and 724 respectively. The low side capacitor for DC-DC C 736 may clamp the voltage from cell 742 at the primary side reference element for DC-DC C 736, which is also the negative terminal of cell 744. As described above in relation to FIG. 2, the low side capacitor for DC-DC C 736 may clamp the voltage from cell 742 as well as all cells lower in the stack of the cells of battery 702.

The low side capacitors for DC-DC power converters 750 and 752 (not shown in FIG. 7) may perform the same function as the low side capacitor for DC-DC C 736. The primary side DC-DC power converters 750 and 752 (not shown in FIG. 7) connect to the negative terminal of cell 744 and therefore may clamp the voltage from cell 742 as well as provide isolation from the primary side to the secondary side.

The arrangement of DC-DC power converters 756, 754 and DC-DC D 738 form an interleaved configuration stacked on power converters 752, 750, DC-DC C 736, DC-DC B 734 and DC-DC A 732. DC-DC power converters 756, 754 and DC-DC D 738 all supply a single load 726. As described above, the low side capacitors for DC-DC power converters 754 and 756 (not shown in FIG. 7) as well as the low side capacitor for DC-DC C 738 may perform a similar function as the low side capacitor for DC-DC C 736. The primary side DC-DC power converters 754 and 756 (not shown in FIG. 7) and the primary side of DC-DC D 738 connect to the negative terminal of cell 746 and therefore may clamp the voltage from all cells stacked below cell 746 as well as provide isolation from the primary side to the secondary side.

In the example of circuit 700, the secondary side of DC-DC power converters 754 and 756 and DC-DC D 738 connect to a single reference voltage, REF 1. Load 726 also connects to voltage reference REF1. In contrast, each of DC-DC power converters 750, 752 and DC-DC C 736 may connect to a separate voltage reference. Power converter 752 supplies load 724 and both load 724 and power converter 752 connect to voltage reference REF4. Power converter 750 supplies load 722 and both load 722 and power converter 750 connect to voltage reference REF3. Power converter DC-DC C 736 supplies load 720 and both load 720 and power converter DC-DC C 736 connect to voltage reference REF2. DC-DC A 732 and DC-DC B 734 supply load 730 and load 730 as well as DC-DC A 732 and DC-DC B 734 connect to voltage reference REF 5. Battery 702 connects to REF6. In some examples, all of the voltage references REF1-REF6 may connect to a common node and therefore all be at the same voltage. In other examples, some voltage references may connect to each other in groups, for example REF2, REF3 and RE4 may all connect to a common node that is different from REF5. In other examples, all the voltage references may be separate.

The example of circuit 700 illustrates several different example configurations of power converters of this disclosure. In other examples, a power converter circuit of this disclosure may be arranged in a different manner that may not be illustrated in FIG. 7. For example, DC-DC A 732 and DC-DC B 734 may each supply a separate load rather than the single load illustrated by FIG. 7.

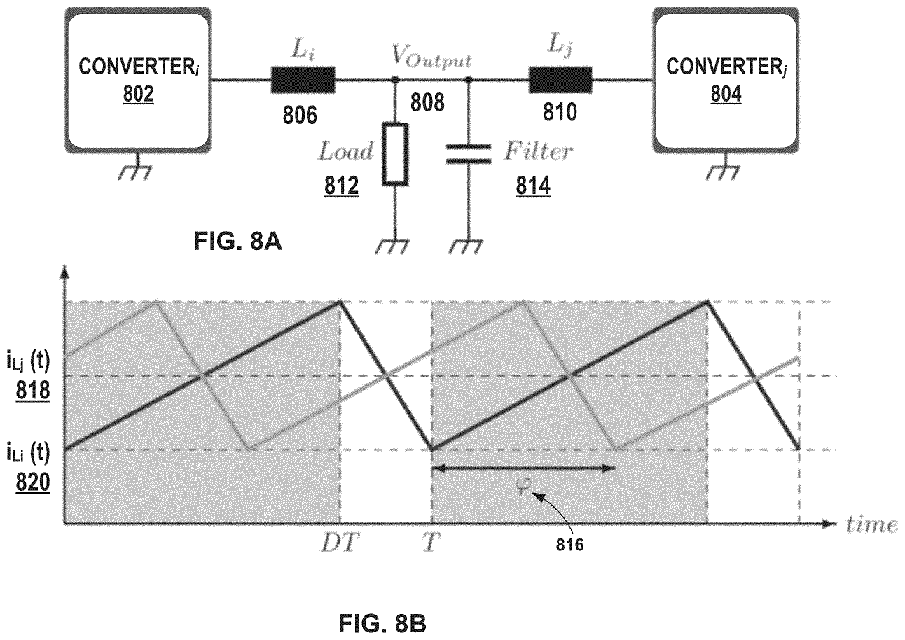

FIG. 8A is a schematic diagram illustrating a second example of an interleaved arrangement of a power converter circuit of this disclosure. In the example of FIG. 8A, two power converters supply a single load 812 with Voutput 808. Filter capacitor 814 connects in parallel with load 812 between Voutput 808 and a reference voltage, which in the example of FIG. 8A is depicted as a ground. Converter 802 connects to Voutput 808 through inductor Li 806. Converter 804 connects to Voutput 808 through inductor Li 810.

FIG. 8B is a time graph illustrating the performance of the interleaved arrangement of FIG. 8A. In the example of FIG. 8B, he output current from converter 802, i_{Li} 820, ramps up for the duration of DT and ramps down for the remainder of period T. The output current for converter 804, i_{Lj} 818, may have similar characteristics, but may be offset from i_{Li} 820 by phase shift φ 816.

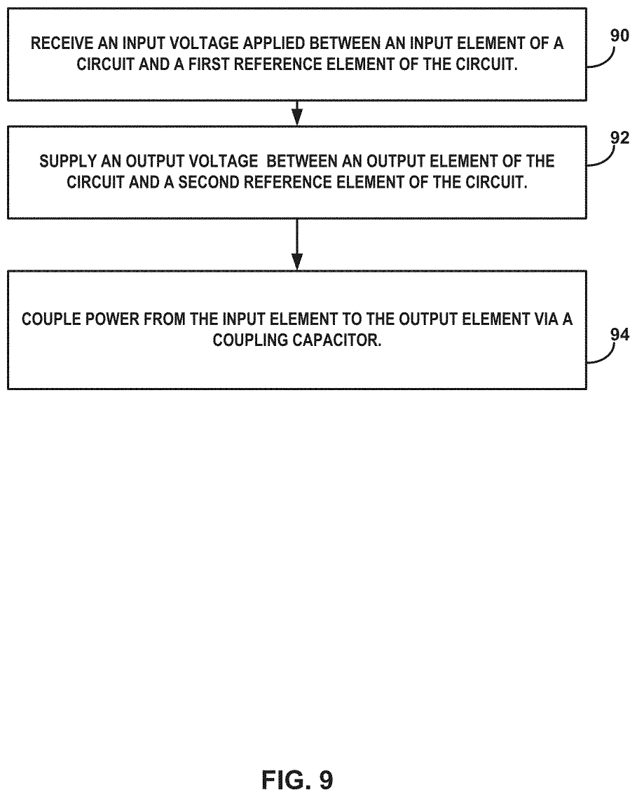

FIG. 9 is a flow diagram illustrating an example operation of the power converter according to one or more techniques of this disclosure. The blocks of FIG. 9 will be described in terms of FIGS. 2 and 3.

A power converter circuit according to this disclosure may receive an input voltage from a source such as from one or more cells of a multi-cell battery, e.g., cell A 340. The input voltage may be applied between an input element, e.g. 371 of the circuit and a first reference element 373 of the circuit (90). In some examples the first reference element may be connected to a reference voltage, such as 315A.

The circuit may supply an output voltage to a load, such as a battery, a motor, lighting or other type of load, connected between an output element, e.g. output element 380 of the circuit and a second reference element, e.g. reference element 375 of the circuit (92). The magnitude of voltage of the input domain at the input element may be greater than or less than or equal to the magnitude of voltage of the output domain at the output element.

The first reference element and the second reference element are electrically connected by a low side capacitor, e.g. C2 364, or a level shifter. The capacitor or level shifter may be configured to isolate the first reference element from the second reference element. As described above in relation to FIG. 1, the isolation provided by the low side capacitor, or level shifter means that the power converter circuits may be stacked or interleaved.

The circuit may convert power from one domain to the other, for example by coupling power from the input element to the output element via a coupling capacitor C1 362, e.g. high side capacitor C1 362. By controlling drive signals to the power converter circuits, each power converter circuit, and a stacked interconnection of power converter circuits, may operate to convert power from one magnitude of voltage to a second magnitude of voltage in either a forward or reverse direction.

The techniques of this disclosure may also be described in the following examples.

Example 1. A circuit comprising a high side capacitor and a low side capacitor, a primary side including a first input element, a first output element, a first reference element. The primary side is configured to receive an input voltage at the first input element. The circuit also includes a secondary side, including a second input element, a second output element and a second reference element, wherein the low side capacitor is connected between the first reference element and the second reference element, wherein the high side capacitor couples the first output element to the second input element, and wherein the secondary side is configured to supply power to a load coupled between the second output element and the second reference element.

Example 2. The circuit of example 1, wherein the first side and the second side form a Zeta converter.

Example 3. The circuit of any of examples 1-2 or any combination thereof, wherein the first side comprises an N-channel metal oxide semiconductor field effect transistor (MOSFET) and an inductor, wherein: the drain of the MOSFET comprises the first input element, the source of the MOSFET comprises the first output element, and the inductor is positioned in series between the first output element and the first reference element.

Example 4. The circuit of any combination of examples 1-3, wherein the second side comprises an N-channel metal oxide semiconductor field effect transistor (MOSFET), an inductor, and a third capacitor, wherein: the drain of the MOSFET comprises the second input element, the source of the MOSFET comprises the second reference element, and the inductor is positioned in series between the second input element and the second output element the third capacitor is positioned in series between the second output element and the second reference element.

Example 5. The circuit of any combination of examples 1-4, wherein the first side and the second side form a Sepic converter.

Example 6. The circuit of any combination of examples 1-5, wherein the first side is configured to receive a first drive signal and the second side is configured to receive a second drive signal, wherein the first drive signal and the first drive signal is controlled by one or more processors.

Example 7. The circuit of any combination of examples 1-6, wherein the one or more processors control the first drive signal and the second drive signal to cause the circuit to transfer power from the second output element to the first input element.

Example 8. The circuit of any combination of examples 1-7, wherein the first capacitor and the second capacitor have approximately the same characteristics.

Example 9. A system comprising: a first circuit, including: a first high side capacitor and a first low side capacitor, a first primary side including a first input element, a first output element, a first reference element. The primary side is configured to receive a first input voltage at the first input element, a first secondary side, including a second input element, a second output element and a second reference element, wherein the first low side capacitor is positioned between the first reference element and the second reference element, wherein the first high side capacitor couples the first output element to the second input element. The system further comprises a second circuit, including: a second high side capacitor and a second low side capacitor, a second primary side including a third input element, a third output element, a third reference element. The second primary side is configured to receive a second input voltage at the third input element, a second secondary side, including a fourth input element, and a fourth output element. The second low side capacitor is positioned between the third reference element to the second reference element. The second high side capacitor couples the third output element to the fourth input element, and the second output element is connected to the fourth output element. The first circuit and the second circuit are configured to convert power across the first circuit and the second circuit, the first input element is connected to the third reference element, and the second low side capacitor is configured to clamp the second input voltage to the first input voltage.

Example 10. The system of example 9, wherein the first reference element is connected to a reference voltage

Example 11. The system of any combination of examples 9-1, wherein the second low side capacitor is configured to clamp the second input voltage to the sum of input voltages between the second reference element and the reference voltage.

Example 12. The system of example 11, further comprising a controller configured to control the operation of the first circuit and the second circuit.

Example 13. The system of any combination of examples 11-12, wherein the controller causes the first circuit and the second circuit to transfer power from the second output element and fourth output element to the first input element and the second input element.

Example 14. The system of any combination of examples 11-13, further comprising: a first battery cell connected between the first input element and the first reference element, a second battery cell connected between the third input element and the third reference element, and wherein the controller is further configured to control the operation of the first circuit and the second circuit such that a charge level of the first battery cell remains approximately equal to a charge level of the second battery cell.

Example 15. The system of any combination of examples 11-14, further comprising sensing circuitry, operatively coupled to the controller, wherein the sensing circuitry is configured to monitor one or more parameters of the first circuit and the second circuit and communicate the status of the one or more parameters to the controller.

Example 16. The system of any combination of examples 11-15, further comprising protection circuitry configured to protect the system from one or more faults, including overvoltage, overcurrent, and over-temperature.

Example 17. The system of any combination of examples 11-16, wherein the first high side capacitor and second high side capacitor are configured to each operate as a flying capacitor.

Example 18. A method comprising: receiving, by a circuit, an input voltage applied between an input element of the circuit and a first reference element of the circuit, supplying, by the circuit, an output voltage between an output element of the circuit and a second reference element of the circuit. The first reference element and the second reference element are electrically connected by a low side capacitor configured to isolate the first reference element from the second reference element, and coupling, by the circuit, power from the input element to the output element via a coupling capacitor.

Example 19. The method of example 18, receiving, by the circuit, a first drive signal to a first portion of the circuit, wherein the first portion of the circuit comprises the input element, and receiving, by the circuit, a second drive signal to a second portion of the circuit, wherein the second portion of the circuit comprises the output element, wherein the first drive signal and the second signal are configured to change a first magnitude of the input voltage to a second magnitude of the output voltage, wherein the first magnitude is different from the second magnitude.

Example 20. The method of any combination of examples 18-19, wherein the circuit is a first circuit and the input voltage is a first input voltage, the method further comprising, clamping, by the low side capacitor, the first reference element to a second input voltage of a second circuit.

Various examples of the disclosure have been described. These and other examples are within the scope of the following claims.

What is claimed is:

1. A circuit comprising:
a high side capacitor and a low side capacitor;
a primary side including a first input element, a first output element, a first reference element, wherein the primary side configured to receive an input voltage at the first input element; and
a secondary side, including a second input element, a second output element and a second reference element,
wherein the low side capacitor is positioned in series between the first reference element and the second reference element,
wherein the high side capacitor couples the first output element to the second input element, and
wherein the secondary side is configured to supply power to a load coupled between the second output element and the second reference element.

2. The circuit of claim 1, wherein the first side and the second side form a Zeta converter.

3. The circuit of claim 2, wherein the first side comprises an N-channel metal oxide semiconductor field effect transistor (MOSFET) and an inductor, wherein:
the drain of the MOSFET comprises the first input element,
the source of the MOSFET comprises the first output element, and
the inductor is positioned in series between the first output element and the first reference element.

4. The circuit of claim 2, wherein the second side comprises an N-channel metal oxide semiconductor field effect transistor (MOSFET), an inductor, and a third capacitor, wherein:
the drain of the MOSFET comprises the second input element,
the source of the MOSFET comprises the second reference element,
the inductor is positioned in series between the second input element and the second output element, and
the third capacitor is positioned in series between the second output element and the second reference element.

5. The circuit of claim 1, wherein the first side and the second side form a Sepic converter.

6. The circuit of claim 1, wherein the first side is configured to receive a first drive signal and the second side is configured to receive a second drive signal, wherein the first drive signal and the first drive signal is controlled by one or more processors.

7. The circuit of claim 6, wherein the one or more processors control the first drive signal and the second drive signal to cause the circuit to transfer power from the load to the first input element.

8. The circuit of claim 1, wherein the first capacitor and the second capacitor have approximately the same characteristics.

9. A system comprising:
a first circuit, including:
a first high side capacitor and a first low side capacitor;
a first primary side including a first input element, a first output element, a first reference element, wherein the primary side is configured to receive a first input voltage at the first input element;
a first secondary side, including a second input element, a second output element and a second reference element,
wherein the first low side capacitor is positioned in series between the first reference element and the second reference element,
wherein the first high side capacitor couples the first output element to the second input element; and
a second circuit, including:
a second high side capacitor and a second low side capacitor;
a second primary side including a third input element, a third output element, a third reference element, wherein the second primary side is configured to receive a second input voltage at the third input element;
a second secondary side, including a fourth input element, and a fourth output element,
wherein the second low side capacitor is positioned in series between the third reference element to the second reference element,
wherein the second high side capacitor couples the third output element to the fourth input element,
wherein the second output element is connected to the fourth output element
wherein the first circuit and the second circuit are configured to,
wherein the first input element is connected to the third reference element, and wherein the second low side capacitor is configured to clamp the second input voltage to the first input voltage.

10. The system of claim 9, wherein the first reference element is connected to a reference voltage.

11. The system of claim 10, wherein the second low side capacitor is configured to clamp the second input voltage to the sum of input voltages between the second reference element and the reference voltage.

12. The system of claim 9, further comprising a controller configured to control the operation of the first circuit and the second circuit.

13. The system of claim 12, wherein the controller causes the first circuit and the second circuit to transfer power from the second output element and fourth output element load to the first input element and the second input element.

14. The system of claim 12, further comprising:
a first battery cell connected between the first input element and the first reference element;
a second battery cell connected between the third input element and the third reference element, and
wherein the controller is further configured to control the operation of the first circuit and the second circuit such that a charge level of the first battery cell remains approximately equal to a charge level of the second battery cell.

15. The system of claim 12, further comprising sensing circuitry, operatively coupled to the controller, wherein the sensing circuitry is configured to monitor one or more parameters of the first circuit and the second circuit and communicate the status of the one or more parameters to the controller.

16. The system of claim 9, further comprising protection circuitry configured to protect the system from one or more faults, including overvoltage, overcurrent, and over-temperature.

17. The system of claim 9, wherein the first high side capacitor and second high side capacitor are configured to each operate as a flying capacitor.

18. A method comprising:
receiving, by a circuit, an input voltage applied between an input element of the circuit and a first reference element of the circuit;
supplying, by the circuit, an output voltage between an output element of the circuit and a second reference element of the circuit,
wherein the first reference element and the second reference element are electrically connected by a low side capacitor configured to isolate the first reference element from the second reference element, and
coupling, by the circuit, power from the input element to the output element via a coupling capacitor.

19. The method of claim 18, further comprising
receiving, by the circuit, a first drive signal to a first portion of the circuit, wherein the first portion of the circuit comprises the input element; and
receiving, by the circuit, a second drive signal to a second portion of the circuit, wherein the second portion of the circuit comprises the output element, wherein the first drive signal and the second signal are configured to change a first magnitude of the input voltage to a second magnitude of the output voltage, wherein the first magnitude is different from the second magnitude.

20. The method of claim 18, wherein the circuit is a first circuit and the input voltage is a first input voltage, the method further comprising;
clamping, by the low side capacitor, the first reference element to a second input voltage of a second circuit.
